(19) United States
(12) Patent Application Publication
(10) Pub. No.: US 2006/0250389 A1
(43) Pub. Date: Nov. 9, 2006

(54) Method for creating virtual reality from real three-dimensional environment

(76) Inventor: Viatcheslav L. Gorelenkov, Gaithersburg, MD (US)

Correspondence Address: Mr. Viatcheslav L. Gorelenkov, 34 Solitaire Court, Gaithersburg, MD, 20878, US

(21) Appl. No.: 11/416,415

(22) Filed: May 3, 2006

Related U.S. Application Data
(60) Provisional application No. 60/678,946, filed on May 9, 2005.

(51) Int. Cl. G06T 15/00

(52) U.S. Cl. 345/419

(57) ABSTRACT

A simulation of a real three-dimensional environment is created in the form of observation points and walks between them. Observation points provide the user with a 360-degree panoramic view and are created from the plurality of overlapping images taken from a single point, resulting in the creation of one environment map for each point. The environment is then simulated by displaying a transformed environment map. Walks show the transition from one observation point to another and are created from a plurality of key images taken on the path from the starting point to the ending point. In response to an input specifying a required transition to another point, a sequence of images created by the transformation of the correspondent key image is displayed. Transformation is determined by finding the image correspondence for a pair of neighboring key images and the calculation of warping.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Technical Field

The present invention relates in general to image processing and, in particular, to a method and system for developing a virtual reality environment. More particularly, the present invention relates to a method and system for constructing a virtual reality environment from real world images.

2. Description of the Related Art

In many computer graphics application programs it is desirable to provide a realistic simulation of the real environment. For example, many Internet applications can show “virtual tours”, which consist of series of panoramic images taken from some points and shown in a special viewer. Although such programs are often easy to create and they may give some impression of the real environment selected for simulation, these programs fail to offer realistic views due to the discrete nature of points chosen to be panoramic points and the finite number of them.

There is another class of computer graphics application programs, mostly computer games, which are capable of generating high-detailed views of three-dimensional environments. But because this class of programs relies on mathematical models rather then real world images, it requires the preparation of vast amounts of data, special computer skills and a lot of effort. Despite the good visual impression, these programs cannot simulate real objects, such as museums, real estate and parks. They are mostly suited for unreal environment, which is much easier to describe by mathematical models.

### BRIEF SUMMARY OF THE INVENTION

The present invention overcomes the shortcomings in the art by providing a method and system that permit a user lacking specialized programming skills and training to produce a realistic simulation of a real world environment within a realistic timeframe and amount of effort.

According to the present invention, a simulation of a real three-dimensional environment is created in the form of observation points and walks between them. Observation points provide the user with a 360-degree panoramic view and are created from the plurality of overlapping images taken from a single point, resulting in the creation of one environment map for each point. The environment is then simulated by displaying a transformed environment map. Walks show the transition from one observation point to another and are created from a plurality of key images taken on the path from the starting point to the ending point. In response to an input specifying a required transition to another point, a sequence of images created by the transformation of the correspondent key image is displayed. Transformation is determined by finding the image correspondence for a pair of neighboring key images and the calculation of warping, which would be required if an observer had been on the intermediate position between two positions where these images been taken.

All objects, features and advantages of the present invention will become apparent in the following detailed written description.

### BRIEF DESCRIPTION OF THE SEVERAL VIEWS OF THE DRAWING

For the present invention to be clearly understood and readily practiced, the present invention will be described with following Figures wherein:

FIG. 1 illustrates the principle of acquiring information about three-dimensional environment from the scene using the method of the present invention;

FIG. 2 is a logical flowchart for applying the lens model to series of overlapped images taken from an observation point;

FIG. 3 is a high-level logical flowchart for the process of applying the lens model;

FIG. 4 is a formula for the generic lens model;

FIG. 5 is a formula for the lens model for “thin” lens;

FIG. 6 is a formula that describes the lens model in the case of a complex lens with a high distortion or a mirror;

FIG. 7 and FIG. 8 are equations of the lens model required by the algorithm shown in FIG. 3;

FIG. 9 is a logical flowchart for the environment map creation for an observation point;

FIG. 10 is a logical flowchart for the creation of the sequence of images for a walk;

FIG. 11 is a high-level logical flowchart for the creation of a transformation for rendering of one walk image from a pair of key images;

FIG. 12 is a high-level logical flowchart for the creation of a single walk image by applying the transformation created as shown in FIG. 11;

FIG. 13 illustrates the process of the simulation of a three-dimensional environment using the present invention;

### DETAILED DESCRIPTION OF THE INVENTION

Introduction

The present invention allows the demonstration of a realistic view of real three-dimensional surroundings. All present methods of doing this in general display only limited numbers of photos, panoramas or video clips. This information is still fragmental and does not allowed the viewer to get the full impression about the objects selected for presentation.

The present invention proposes a different approach to the presentation of information about a three-dimensional environment: using a directional graph with observation points in the vertices and walks from one point to another in the graph edges. This solution scales much better than the present ones and allows the user to create the simulation of a real three-dimensional environment with realistic requirements to the user skills level, timeframe and effort.

1. Taking Information From the Scene

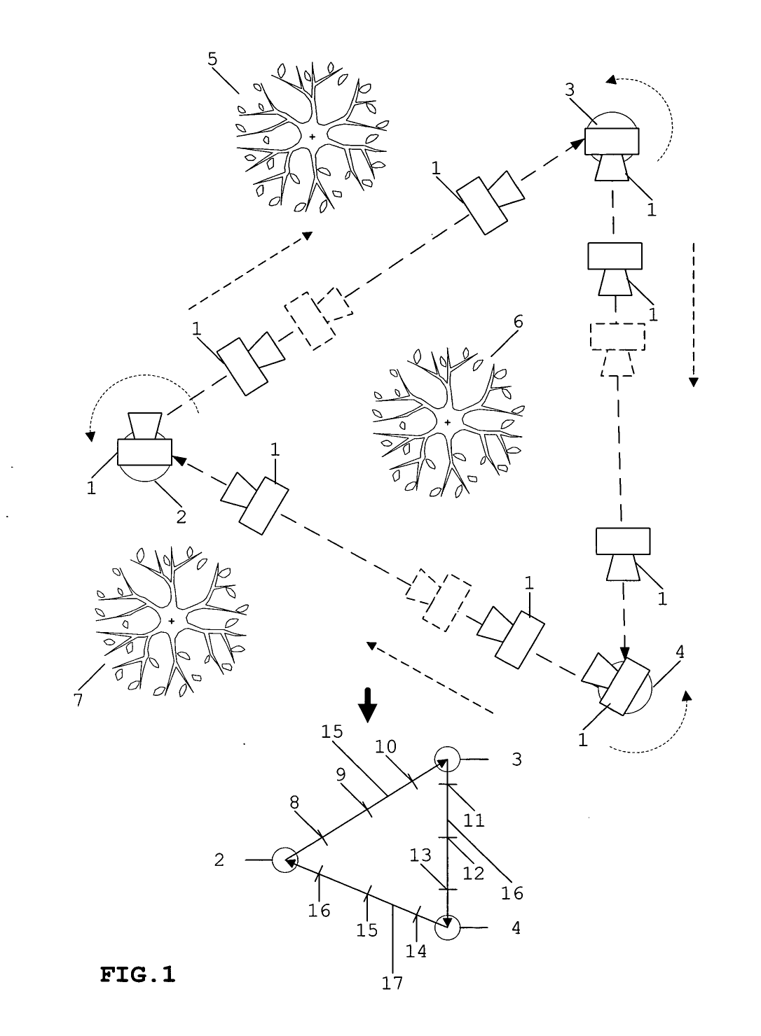

FIG. 1 depicts the principle of acquiring information about a three-dimensional environment from the scene. As illustrated, camera 1 is used to take a series of photo shots. The scene consists of observation points 2, 3, 4 and walks from one observation point to another 15, 16, 17. Camera 1 takes a series of overlapping images at each of the observation points. Later, these series of images will be combined into one environment map. In addition to gathering information about the observation points, camera 1 also takes key images for walks. These key images are being taken on the path from one observation point to another. For walk 15 from point 2 to point 3, the key images are being taken at positions 8, 9, 10. For walk 16 from point 3 to point 4, the key images are being taken at positions 11, 12, 13. For walk 17 from point 4 to point 2, the key images are being taken on position 14, 15, 16.

2. Creation of Observation Points

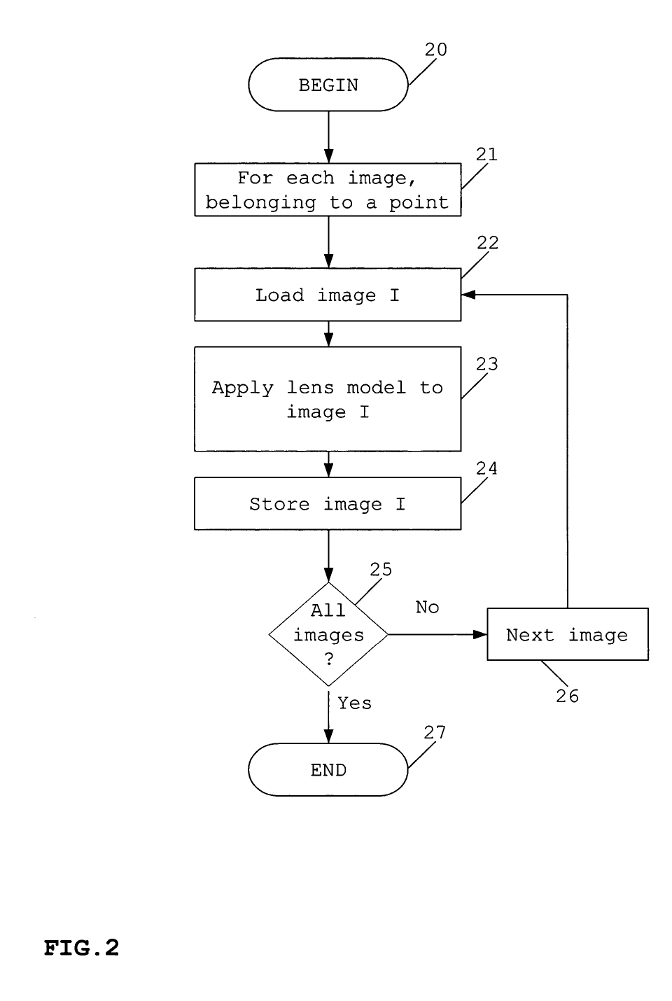

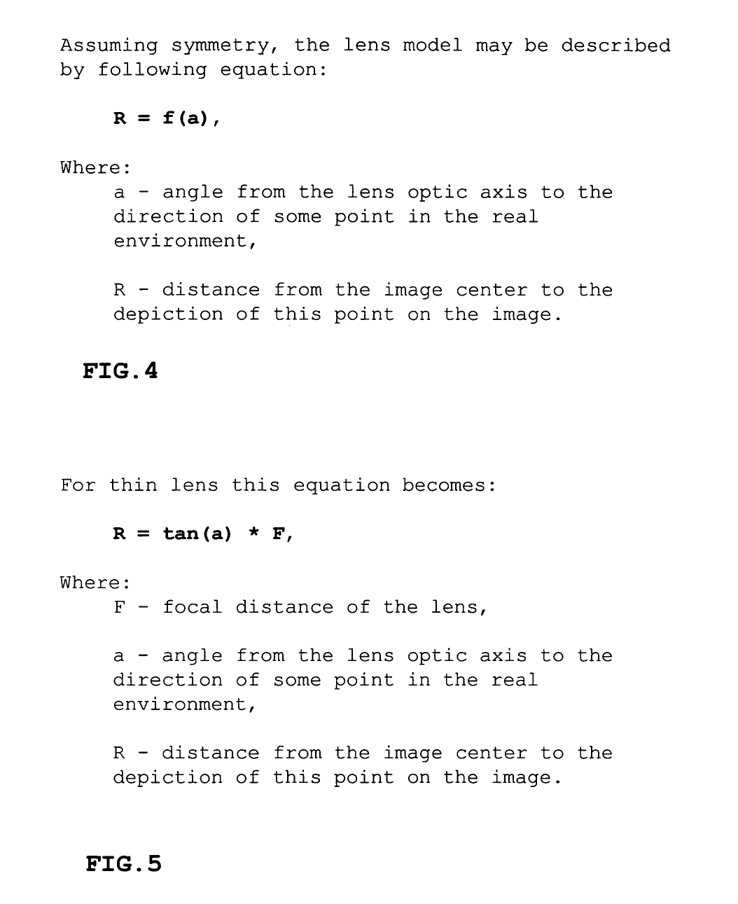

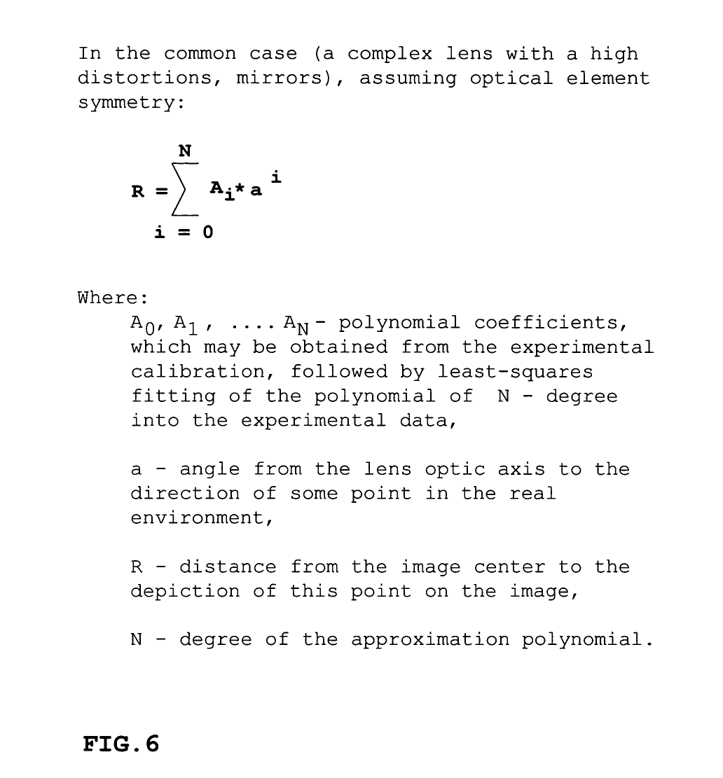

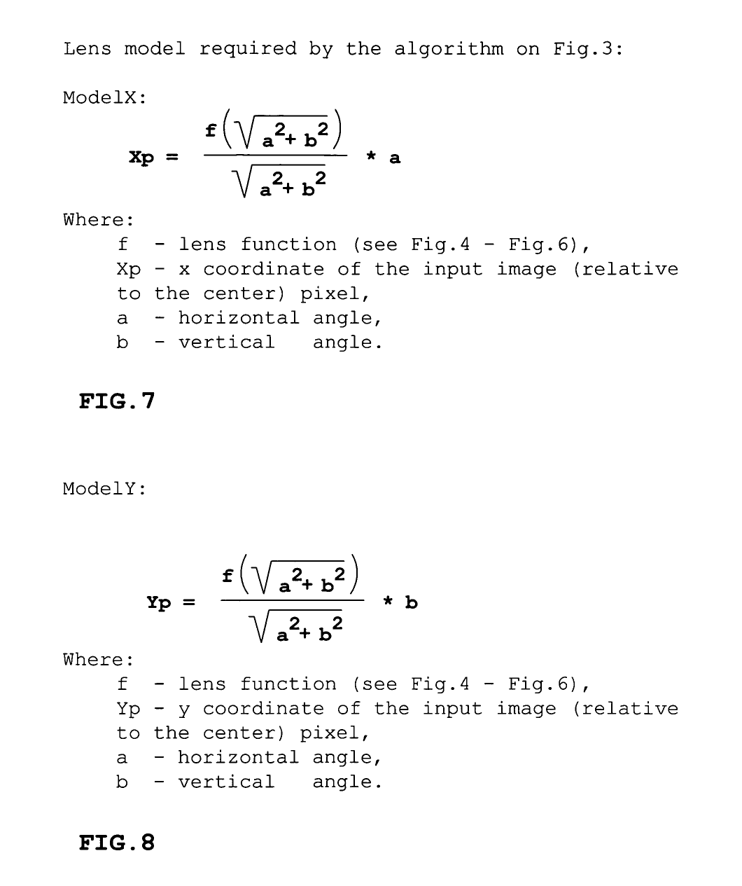

FIG. 2 illustrates the logical flowchart for applying the lens model to a series of overlapping images taken from an observation point. The lens model will be applied to all these images as a means of transformation. The lens model, which is indicated on FIG. 4, is a function that allows the user to obtain information about the spatial position of image points. The formula for lens model in the case of a so-called ‘thin’ lens is located FIG. 5. This model may describe the majority of consumer-grade lenses. In the case of complex lenses with a high level of distortion or curved mirrors, which may be used in conjunction with the camera as well, the lens model described in FIG. 6 may be required. The formula in FIG. 6 assumes that an experimental calibration followed by least squares fitting of the approximation polynomial is done to calculate the polynomial coefficients.

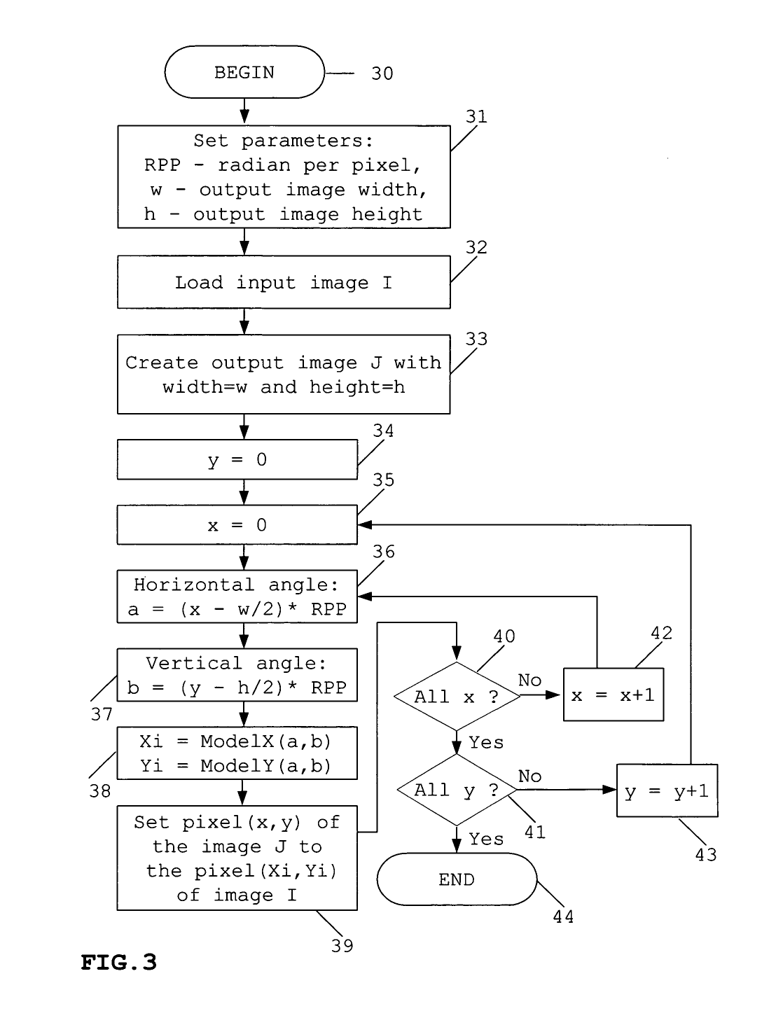

FIG. 3 illustrates a high-level logical flowchart for the process of applying the lens model. Input parameters for environment map are set in block 31: radian per pixel, width and height. Then the resulting angles are calculated in blocs 36 and 37 for each pixel of the environment map. The lens model is then applied in block 38 as the formulas from FIG. 7 and FIG. 8. Knowing the correspondence between the input image and the output environment map, each pixel of the environment map is set to the correspondent position of the input image in block 39. This process is repeated for each pixel of the environment map.

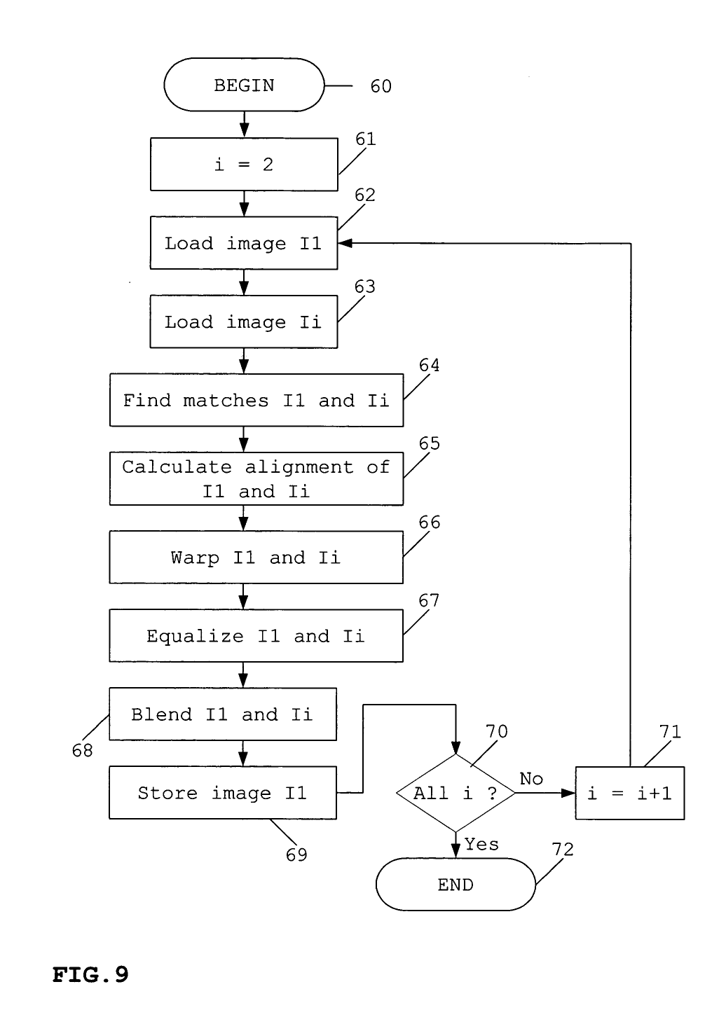

FIG. 9 illustrates the logical flowchart for the creation of the environment map for an observation point. This process assumes that the transformation of input images taken from the scene to environment maps, described in FIG. 3 and FIG. 4 has already been done. Right now it is necessary to combine these partial environment maps into one whole environment map for an observation point. This process is performed as the pair wise combining of the images. A new image is been added to the environment map at each step of the algorithm. The process is started in block 64 from matches finding. After the matches are found, the alignment of the image pair is calculated in block 65 as mean value of the image matches. As the images alignment and the matches between the images are defined, the algorithm will now fit the two-dimensional polynomial at the matches set using least squares method. Afterwards, this polynomial is used in block 66 to warp both images to minimize the contours difference between them. In block 67 the algorithm will perform analysis of the images overlapping area to calculate color and intensities difference of the two images and apply necessary correction to the whole images to minimize these difference in the overlap area, during the process called equalizing. In block 68 the algorithm will analyze each scan line of the overlap area to seamlessly blend them into one image, in the process called blending. The combined image is stored in block 69. All the process will be repeated until all images belonging to the observation point environment map will be combined into one image in this manner.

3. Creation of Walks

The data for walks is created after the all environment maps for the observation points have been created. Each walk is a sequence of images created from a limited number of walk key images. Several non-key intermediate images may be created from a single pair of walk key images.

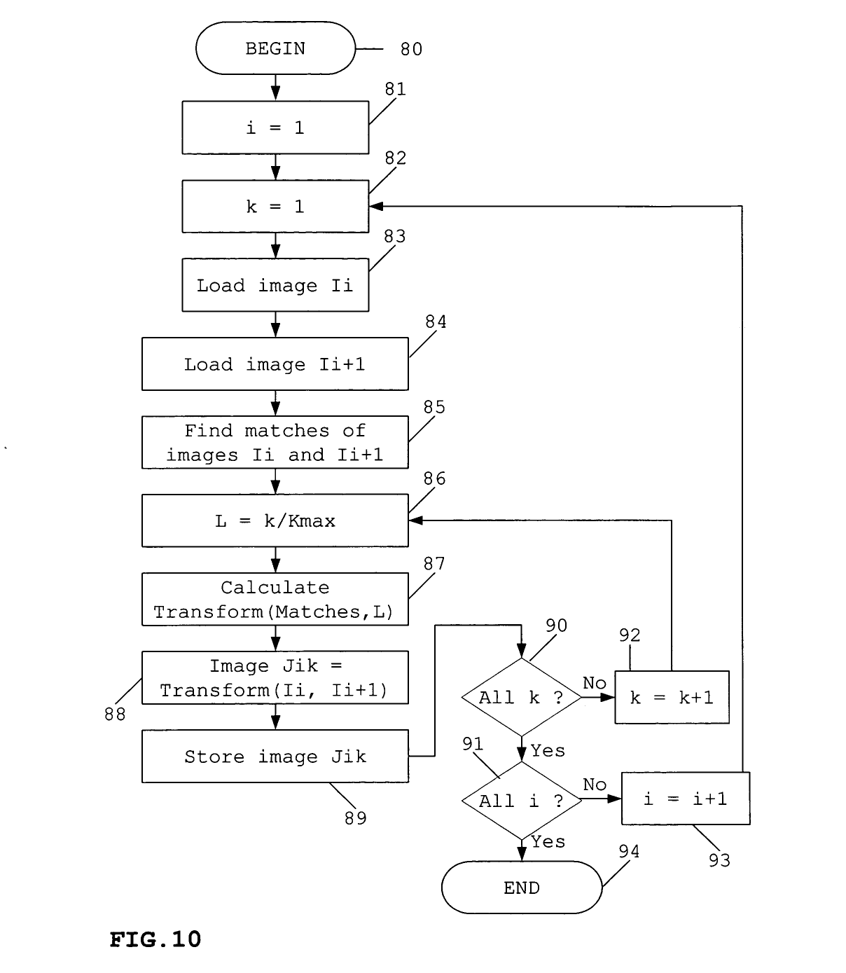

FIG. 10 shows the logical flowchart for the creation of the sequence of images for a walk. The algorithm is analyzing each pair of walk key images. The pair matches for this are found in block 85. Afterwards, the relative distance parameter for walk sequence image is calculated in block 86. With known matches between the key images pair and the relative distance parameter, the algorithm proceeds in calculating the transformation that is required for the walk sequence image.

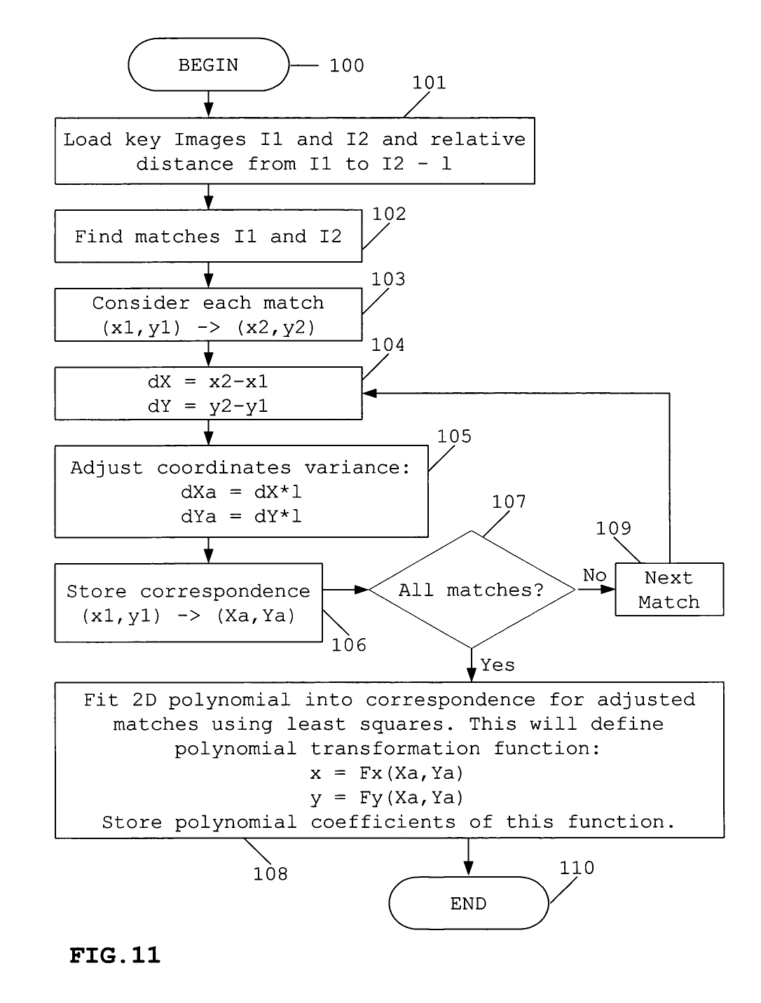

FIG. 11 depicts the high-level logical flowchart for the creation of a transformation for rendering of a single walk image from a pair of key images. Each found match is adjusted by the relative distance parameter in block 105. All of these adjusted matches are stored. The algorithm will then fit the two-dimensional polynomial into a correspondence for the adjusted matches using least squares. This will the define polynomial transformation function in block 108. The algorithm will store the polynomial coefficients of this function.

Referring now back to FIG. 10. After the transformation in the form of a two-dimensional polynomial has been calculated, it will be applied to the first image of the key images pair.

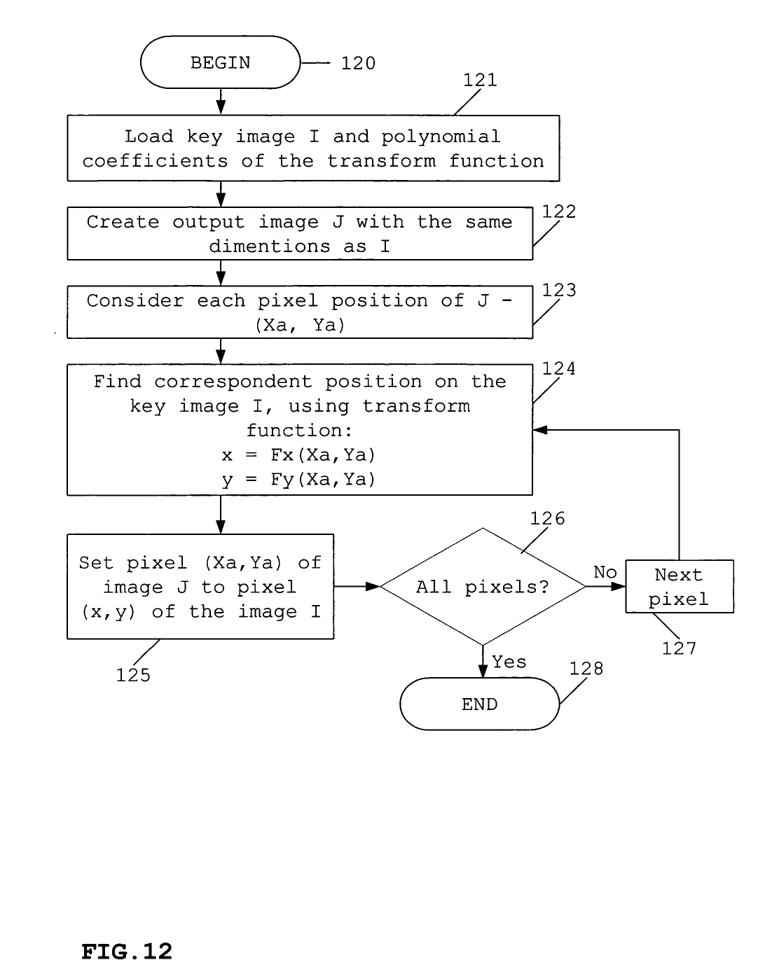

FIG. 12 demonstrates the high-level logical flowchart for the creation of a single walk image by applying the transformation, created as shown in FIG. 11. The first walk sequence image is created in block 122; the correspondence between the walk sequence image and the walk key image is then calculated using the polynomial calculated in FIG. 11 in block 124. The pixel of walk sequence image is then set to the correspondent pixel of the key image in block 125. The process is repeated for all pixel of walk sequence image.

Referring now back again to FIG. 10. The resulting walk sequence image is stored in block 89. This process will be repeated for each pair of the walk key images that resulted in the creation of all sequence of walk.

4. Displaying of Simulation

After all environment maps for all observation points had been created and all walk sequences had been created as well, these data is stored on the storage media. It is possible to store these data as a set of separate files (one file per each environment map or walk image) or store them in one binary data container. It is reasonable to use an appropriate image compression technique to minimize storage requirements. To display the simulation using the method of this invention, it is required to use a computer system with a display, user input devices (such as keyboard, mouse) and a storage media (such as hard-drive). It is also possible to store of the simulation data on central computer server and access the simulation data using the appropriate network protocol, such as HTTP.

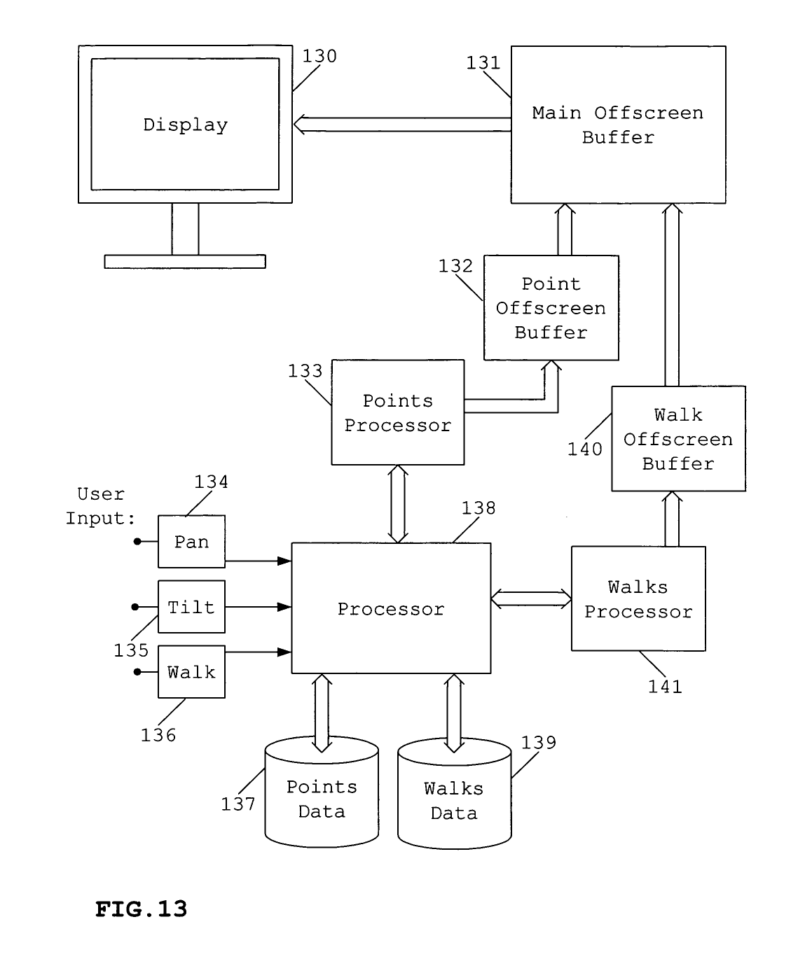

FIG. 13 illustrates the process of the simulation of a tree-dimensional environment with the present invention. The simulation data is stored inside data storage 137 for points data (environment maps) and 139 for walks data (walks sequences). Common data storage may be used to store both types of data as well. Processor 132 executes simulation program. At each moment of time it shows either an observation point by activating the points processor 133 that renders the point data into the point off-screen buffer 132, or a walk sequence by the means of the walk processor 141, that renders the walk sequence into the walk off-screen buffer 140. Both the point off-screen buffer 132 and the walk off-screen buffer 140 render data into the common main off-screen buffer 131, which then renders into display 130. Point processor 133, point off-screen buffer 132, main off-screen buffer 131 as well as walk processor 141 and walk off-screen buffer 140 may be implemented as a part of the simulation software. At the initial moment of time the processor renders the point data from the simulation starting point (refer back to FIG. 1, point 2). User inputs the response into the main simulation program via the user input device(s) 134, 135 and 136. These may be a computer keyboard/mouse or another device best suited for the purpose of simulation program. In response to the changes in pan/tilt from the user interface 134 and 135, the processor will change the environment map transformation parameters for points processor 133, resulting in changing data rendering in point off-screen buffer 132, changing main off-screen buffer 131 and the picture on the display 130. To display a walk to another point in response to user interface 136, processor will use the walk processor to render the walk sequence into the walk off-screen buffer 140, which will be copied into main off-screen buffer 131 and appears on the display 130.

While the present invention has been described in conjunction with preferred embodiments thereof, many modifications and variations will be apparent to those of ordinary skill in the art without departing from the spirit and scope of the invention.

1. A method for providing a simulation of a three-dimensional environment, said method comprising:
360-degree panoramic views from certain points of the three-dimensional space, said points; and
creating of a transitional walkthrough between logically connected points, said walks.

2. The method of claim 1, wherein:
said points are created from a plurality of overlapping images taken from a single position of the three-dimensional space resulting in the creation of one whole environment map for each point, said environment map; and
said walks are created from a plurality of key images taken on the path from the starting point to the ending point, said walk key images.

3. The method of claim 2, and further comprising:
presenting a simulation of said three-dimensional environment by displaying a transformed environment map corresponding the to current view coordinates, such as pan and tilt; and
in response to an input specifying a required transition to another point, displaying a sequence of images, said sequence; and
first image of said sequence is created from the starting point environment map, last image—from the ending point environment map, intermediate images are created by applying a warping transformation, said transformation to the correspondent key image; and
said transformation is determined as a result of the analysis of each pair of neighboring key images by finding of the image correspondence and calculation of warping transformation that will be required would observer have been on the intermediate position between the two positions where these images been taken.

4. A data processing system, comprising:
data processing resources; and
data storage that stores environment simulation software, wherein said environment simulation software, in response to the receipt by said data processing system of a plurality of overlapping images associated with each said point, each overlap is closed by finding matches, calculating alignment, equalizing and warping, resulting in the creation of the environment map, in response to the receipt by said data processing system of a plurality of key images associated with each said walk, each pair of neighboring key images is analyzed by finding the image correspondence and calculating of said transformation which would be required if an observer had been on the intermediate position between the two positions where these images been taken, intermediate images are created by applying said transformation to the correspondent key image.

5. The data processing system of claim 4, and further comprising a display and a user input device, wherein said simulation software presents a simulation of said three-dimensional environment by displaying a transformed environment map corresponding to the current view coordinates, such as pan and tilt, in response to an input specifying the desired changes in view coordinates within said simulation received from said user input device, correspondent parameters of the environment map transformation are changed, in response to an input specifying the required transition to another said point, displaying a sequence of transformed said key images.

6. A program product, comprising:
a data processing usable medium; and
environment simulation software within said data processing usable medium, wherein said environment simulation software, in response to the receipt by said data processing system of a plurality of overlapping images associated with each said point, each overlap is closed by finding matches, calculating of alignment, equalizing and warping, resulting in the creation of the environment map, in response to the receipt by said data processing system of a plurality of key images associated with each said walk, each pair of neighboring key images is analyzed by finding the image correspondence and calculating of said transformation which will be required would observer have been on the intermediate position between the two positions where these images been taken, intermediate images are created by applying said transform to the correspondent key image.

7. The program product of claim 6, wherein said simulation software presents a simulation of said three-dimensional environment by displaying a transformed environment map corresponding to the current view coordinates, such as pan and tilt, in response to an input specifying the desired changes in view coordinates within said simulation received from said user input device, correspondent parameters of the environment map transformation are changed, in response to an input specifying a required transition to another said point, said simulation software displays a sequence of transformed said key images.
